(19) United States
(12) Patent Application Publication
(10) Pub. No.: US 2025/0304257 A1
(43) Pub. Date: Oct. 2, 2025

(54) System and Method for Optimized Airline Passenger Boarding Using Indicator Lights, Colored Pathways and Boarding Pass Guidance

(71) Applicant: David Edward Henry, Cedar Falls, IA (US)

(72) Inventor: David Edward Henry, Cedar Falls, IA (US)

(21) Appl. No.: 18/810,558

(22) Filed: Aug. 21, 2024

Related U.S. Application Data
(63) Continuation-in-part of application No. 18/621,115, filed on Mar. 29, 2024.

(51) Int. Cl. B64D 11/00

(52) U.S. Cl. CPC B64D 11/0015

(57) ABSTRACT

A computer-implemented system and method for efficiently boarding passengers onto an airplane is disclosed. Indicator lights above seats are illuminated when passengers are boarding the aircraft to facilitate the efficient boarding process. The system comprises a database storing passenger information, a processor assigning passengers original and final boarding numbers based on their assigned seats and travel party status, and a memory storing instructions for the processor to optimize the boarding process. Passengers are assigned to boarding groups and provided boarding passes indicating their group number, final boarding number, seat details, and a colored pathway to guide them to their seat via illuminated aisles of matching colors.

### BACKGROUND

The present invention relates generally to the field of airline travel and passenger management. More specifically, the invention relates to systems and methods for efficiently boarding passengers onto an aircraft in an optimized manner to reduce boarding time.

Boarding an aircraft with passengers in an efficient and timely manner remains an area of interest for airlines. Conventional boarding methods, such as back-to-front or outside-in, still result in congestion in the aircraft aisles and increased turn times between flights. This negatively impacts airline scheduling, costs, and the passenger experience.

Some attempts have been made to improve the boarding process. For example, US Patent Application Publication No. 2018/0285782 to Amadeus S.A.S. describes a system for managing passenger information that estimates the time for a late passenger to reach the gate and the probability of the passenger missing their flight. While this can help avoid delaying a flight for late passengers, it does not address optimizing the actual boarding process for passengers who have arrived at the gate on time.

Airlines have also tried assigning boarding groups, but these are typically based on seating class or priority status and still result in many passengers congregating in the gate area and jetway waiting to board. The airline staff must still make sure each passenger boards in the proper order within these broad groups.

There is still a need for an improved passenger boarding system that minimizes congestion and aisle interference to enable faster boarding from the gate and shorter turn times between flights. Ideally, such a system would provide a specific optimized boarding order and group to each individual passenger based on their assigned seat, and guide them through the boarding process accordingly. The system should be adaptable to different aircraft configurations and easy for gate staff and passengers to understand and follow.

The present invention addresses these needs by providing a novel efficient aircraft boarding system and method that assigns each passenger a specific boarding group and number based on their seat location and the optimal order for filling the plane while minimizing congestion. Passengers line up according to their boarding group and number, and are guided to their seats row by row and side by side to enable efficient stowing of luggage and seating with minimal interference. This enables an optimal flow of passengers onto the plane to significantly reduce boarding times compared to conventional methods.

### SUMMARY

The present invention provides a computer-implemented system and method for efficiently boarding passengers onto an airplane in an optimized manner to reduce boarding times. The system includes a database storing passenger information such as assigned seats, a processor, and a memory storing instructions executed by the processor to perform the boarding optimization.

The processor assigns each passenger an original boarding number based on their assigned seat, with passengers in window seats near the rear of the plane receiving the lowest numbers. Passengers traveling together in parties are identified based on matching reservation record locators and assigned the same final boarding number, which is the lowest original number of any passenger in the party.

Passengers are then assigned to boarding groups based on their final boarding numbers, with lower numbers boarding first. The airplane aisles are each illuminated a different color. Boarding passes are generated for each passenger indicating their group number, final boarding number, seat number, seat type, which side of the plane their seat is on, which colored aisle leads to their seat, and a diagram of their assigned seat with a colored pathway from the plane entrance.

A display device at the gate shows the boarding number of the next passenger to board. The method optimizes the boarding order to fill the plane back to front and outside in, while keeping parties together and minimizing congestion. The system is adaptable to different airplane seating configurations and easy for gate agents and passengers to implement.

The boarding passes guide passengers to their seats by indicating the appropriate colored aisle to follow. The display device can include multiple screens positioned at various heights in the gate area to form multiple boarding lines. Audio or visual alerts notify passengers attempting to board out of order.

In summary, the present invention provides an efficient computerized airline boarding system that assigns passengers an optimal boarding group and number based on their seat location and guides them through the process to minimize aisle interference and reduce overall boarding times. The system improves upon existing methods by providing a specific optimized boarding order to each passenger that accounts for parties traveling together and is simple to implement.

Additional features and advantages of the invention will be set forth in the description which follows, and in part will be obvious from the description, or may be learned by the practice of the invention. These and other features of the present invention will become more fully apparent from the following description, or may be learned by the practice of the invention as set forth hereinafter.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 illustrates a computer-implemented system for efficiently boarding passengers onto an airplane.

FIG. 2 illustrates a flowchart of the boarding number assignment process.

FIG. 3 illustrates an example boarding pass.

FIG. 4 illustrates an airplane with indicator lights above seats.

FIG. 5 illustrates an airplane with indicator lights above seats illuminated to guide passengers to their assigned seats.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word or as used herein means any one member of a particular list and also includes any combination of members of that list. Further, one should note that conditional language, such as, among others, “can,” “could,” “might”, or “may” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

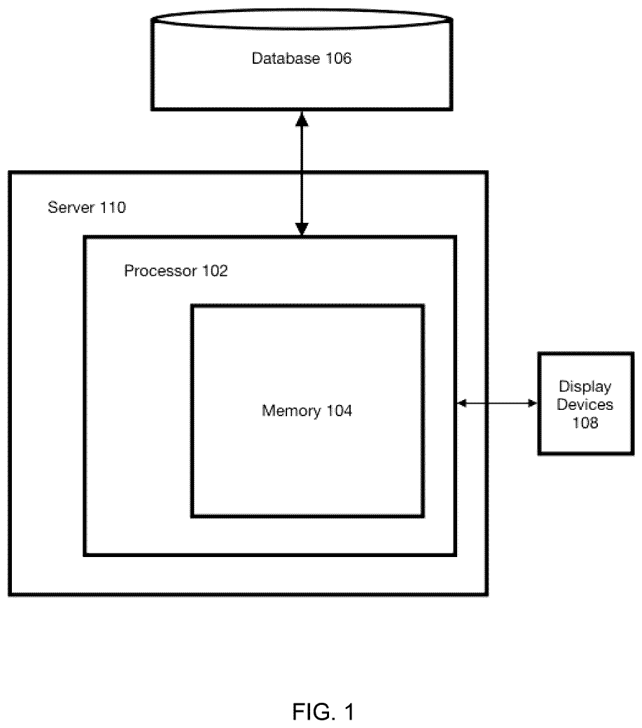

FIG. 1 illustrates a computer-implemented system for efficiently boarding passengers onto an airplane. The system includes a processor 102, a memory 104 coupled to the processor 102, and a database 106 coupled to the processor 102. The memory 104 stores instructions that, when executed by the processor 102, cause the system to perform the passenger boarding operations described herein.

The database 106 stores passenger information including a passenger number, record locator, assigned seat, seat type (e.g. window, middle, aisle), priority status, and number of passengers in a party associated with each passenger. The database 106 may be implemented using any suitable database technology, such as a relational database management system (RDBMS) like MySQL, PostgreSQL, Oracle Database, or Microsoft SQL Server. Alternatively, a NoSQL database like MongoDB, Cassandra or Couchbase could be used for improved scalability.

The processor 102 may be any type of general-purpose CPU such as those made by Intel or AMD. Alternatively, the processor 102 could be an application-specific integrated circuit (ASIC) customized for this system. The memory 104 may include both volatile memory such as RAM and non-volatile storage such as a hard disk drive, solid state drive, or flash memory.

The system also includes one or more display devices 108 coupled to the processor 102. The display devices 108 may include a plurality of screens positioned at eye level, chest level, waist level, hanging from a ceiling, or on a ground of a boarding area. The display devices 108 may also include permanent signage indicating boarding numbers in the boarding area. The display devices 108 are controlled by the processor 102 to display the boarding number of the next passenger(s) to board the airplane.

To assign boarding numbers, the processor 102 first assigns an original boarding number to each passenger based on their assigned seat, with passengers in window seats near the rear of the plane receiving the lowest numbers. The processor 102 then identifies parties traveling together based on matching record locators in the database 106. Each passenger in an identified party is assigned the same final boarding number, which is the lowest original number of any passenger in that party.

Next, the processor 102 assigns a group number to each passenger based on their final boarding number, with lower final numbers receiving lower group numbers. Efficiently grouping passengers in this way streamlines the boarding process.

The processor 102 generates a unique boarding pass for each passenger that includes their group number, final boarding number, seat number, seat type, and an indication of whether their seat is on the left or right side of the plane. The boarding pass may be a printed document, or an electronic pass delivered via email or mobile app.

In some embodiments, each aisle of the airplane is illuminated with a different color (e.g. using colored LED lights), and the boarding pass includes an indication of which colored aisle leads to the passenger's seat. The boarding pass may also include a diagram of the airplane seating with a colored pathway from the entrance to the passenger's assigned seat. This color-coded aisle lighting and pathway information guides passengers to their seats more efficiently.

During boarding, the processor 102 controls the display device(s) 108 to show the boarding number of the next passenger who should board. In some configurations, a second display device shows the boarding number of the second-next passenger simultaneously, where the second-next passenger's number is consecutive with the current boarding number. The two display devices can be positioned to form two boarding lines in the pre-boarding area.

In some embodiments the system may be implemented using a client-server architecture, with the processor 102, memory 104, and database 106 residing on a server. The server may be a cloud-based server, such as an Amazon Web Services EC2 instance or a Microsoft Azure virtual machine, allowing the system to scale easily to accommodate any number of passengers and flights. The display devices 108 may be relatively thin clients that receive instructions from the server over a network, such as wired Ethernet, Wi-Fi (IEEE 802.11), or a cellular data connection (4G/LTE or 5G).

The server may provide a web-based interface for airport staff to access and manage the system. The interface may be implemented using web technologies such as HTML, CSS, JavaScript, and AJAX. On the backend, the server may utilize a web application framework such as Ruby on Rails, Django (Python), Express.js (Node.js), or Laravel (PHP) to handle API requests and render the user interface.

For system security, the server and database should be protected behind a firewall and network security measures like SSL/TLS encryption for data in transit. The server operating system and all software dependencies must be kept up-to-date and regularly patched against vulnerabilities. Access to the system should be limited to authorized personnel only, with strong authentication methods like two-factor authentication.

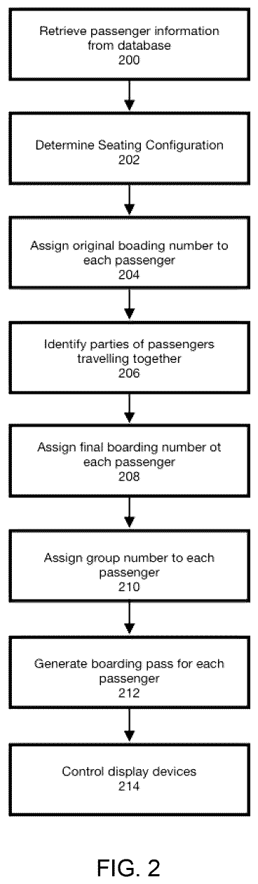

FIG. 2 illustrates a flowchart of the boarding number assignment process performed by the computer-implemented system of FIG. 1. The process begins at step 200 when the processor 102 retrieves passenger information from the database 106. The passenger information includes a passenger number, record locator, assigned seat, seat type (e.g. window, middle, aisle), priority status, and number of passengers in a party associated with each passenger.

At step 202, the processor 102 determines the seating configuration of the airplane, including the number of rows, number of seats per row, and location of each seat. This information may be stored in the database 106 or retrieved from another system via an application programming interface (API). The processor 102 may utilize a JSON parser such as Jackson (Java), to extract the seating configuration details from a JSON-formatted API response.

Using the seating configuration, at step 204 the processor 102 assigns an original boarding number to each passenger based primarily on their assigned seat location. The original boarding numbers are assigned such that passengers with window seats near the rear of the airplane receive lower numbers than passengers with aisle seats near the front. This numbering scheme is designed to fill the airplane from back to front, avoiding aisle congestion.

In addition to seat location, the original boarding number assignment of step 204 may consider other factors. For example, passengers with a higher priority status (e.g. first class, frequent flyer) may receive lower original numbers than standard passengers. As another example, passengers with a large amount of carry-on luggage may receive higher original numbers so they can board later and avoid blocking the aisle while stowing their bags.

At step 206, the processor 102 identifies parties of passengers traveling together by searching for identical record locators in the passenger information. The record locator serves as a unique identifier for each party's reservation. The processor 102 may use a regular expression (regex) pattern to match record locator formats from different reservation systems.

After identifying parties, at step 208 the processor 102 assigns a final boarding number to each passenger in an identified party. The final boarding number for each passenger in the party is set to the lowest original boarding number that was assigned to any passenger in that party at step 204. In this way, passengers in the same party will have the same final boarding number and can board together.

The processor 102 may implement step 208 using a hash map data structure (e.g. HashMap in Java, Dictionary in C#) that maps each party's record locator to the lowest original number in that party. At step 210, the processor 102 assigns a group number to each passenger based on their final boarding number from step 208. Passengers with lower final boarding numbers are assigned to lower group numbers. For example, final boarding numbers 1-30 may be assigned to Group 1, numbers 31-60 to Group 2, etc. The number of passengers per group may be a fixed configuration parameter or dynamically determined based on the airplane capacity. The processor 102 may implement step 210 using a sorted collection (e.g. TreeSet in Java) to efficiently divide the final numbers into contiguous ranges per group.

At step 212, the processor 102 generates a boarding pass for each passenger. The boarding pass includes the passenger's group number, final boarding number, seat number, seat type (e.g. window, middle, aisle), and an indication of whether the seat is on the left or right side of the airplane. The boarding pass may be generated in various formats such as PDF, QR code, or Apple Wallet/Google Pay pass, and delivered to the passenger via email, text message, or mobile app. The processor 102 may utilize a PDF library such as iText (Java) or iTextSharp (C#) to generate PDF boarding passes, or a library like ZXing to create QR codes.

Finally, at step 214, the processor 102 controls one or more display devices 108 to display the boarding number of the next passenger who should board the airplane. The display devices 108 may include screens or monitors positioned at various heights (e.g. eye level, chest level, waist level), hanging from the ceiling, or mounted on the ground. The processor 102 sends the boarding number information to the display devices 108 via a wired (e.g. Ethernet, USB) or wireless (e.g. Wi-Fi, Bluetooth) connection. The display devices 108 may run a lightweight client application to receive and display the boarding numbers, or they may simply display a web page served by the processor 102.

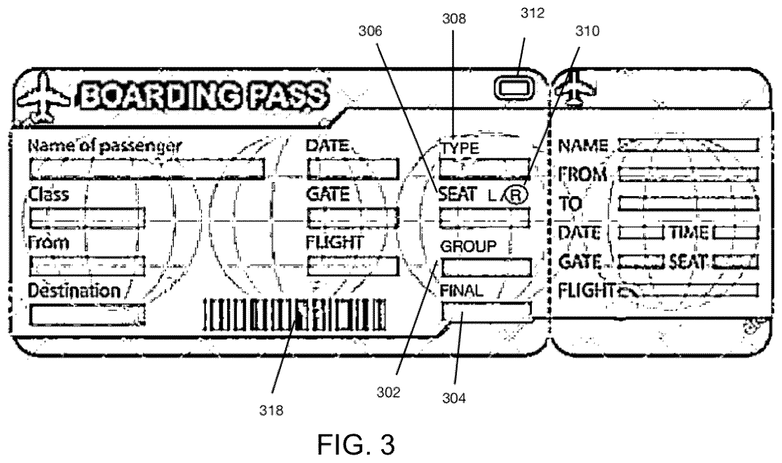

FIG. 3 illustrates an example boarding pass 300 generated by the computer-implemented system for efficiently boarding passengers onto an airplane. The boarding pass 300 includes several key information elements to guide the passenger during the boarding process.

The group number 302 indicates the boarding group to which the passenger is assigned. Passengers are assigned a group number based on their final boarding number, with lower final boarding numbers receiving lower group numbers. This allows passengers to board in an efficient order.

The final boarding number 304 represents the passenger's place in the overall boarding queue. The final boarding number is determined by first assigning an original boarding number to each passenger based on their assigned seat, favoring passengers with window seats near the rear of the plane. Then, passengers traveling in parties are assigned the lowest original boarding number of anyone in their party.

The boarding pass 300 also prominently displays the passenger's seat number 306 and seat type 308. The seat type 308 may indicate whether the seat is a window, middle, aisle, or center seat (in rows with at least four seats across). This information helps the passenger locate their seat and stow their carry-on luggage appropriately.

To further guide the passenger to their seat, the boarding pass 300 includes an indication 310 of whether the seat is on the left or right side of the airplane. Additionally, the boarding pass 300 specifies which aisle leads to the passenger's seat by displaying a colored aisle indicator 312. Each aisle on the airplane is illuminated with a different color, and the colored aisle indicator 312 matches the color of the illuminated aisle that leads to the passenger's seat, per claim 16.

The boarding pass 300 also contains a diagram (not shown) of the airplane seating with a colored pathway from the entrance of the airplane to the passenger's assigned seat. This diagram corresponds acts as a seat map depicting a location of the assigned seat on the airplane. The colored pathway matches the color of the illuminated aisle.

In some embodiments, the boarding pass 300 may include visual indicators of the amount of carry-on luggage allowed for the passenger based on their seat type. For example, the boarding pass 300 may display icons representing the number and/or size of permitted carry-on items.

The processor 102 generates the customized boarding pass 300 for each passenger based on the passenger information stored in the database 106, which includes fields such as the passenger number, record locator, assigned seat, seat type, priority status, and number of passengers in the party. The processor 102 executes instructions stored in the memory 104 to assign original boarding numbers, identify parties traveling together, determine final boarding numbers, and assign group numbers according to the logic.

The processor 102 also controls one or more display devices 108 to show the boarding number of the next passenger who should board. The display devices 108 may be positioned at various locations in the boarding area to form an orderly queue.

The boarding pass 300 may be printed on paper, displayed on a mobile device screen, or stored in a digital wallet app. The 2D barcode 318 allows the boarding pass to be scanned at security checkpoints and at the gate. The barcode 318 is generated according to the IATA BCBP standard using a PDF417 symbology and encoding all relevant passenger information. The system may use a barcode generation library such as Zint or Barcode4J to create the barcode 318 image.

The boarding pass 300 may be delivered to the passenger via email as a PDF attachment, through a mobile app notification, or as an SMS message with a download link. The system can leverage common communication protocols like SMTP, HTTP, or SMPP to transmit the boarding pass 300 to the passenger's device. For added security, the boarding pass PDF may be digitally signed or encrypted using standard cryptographic techniques to prevent forgery or tampering.

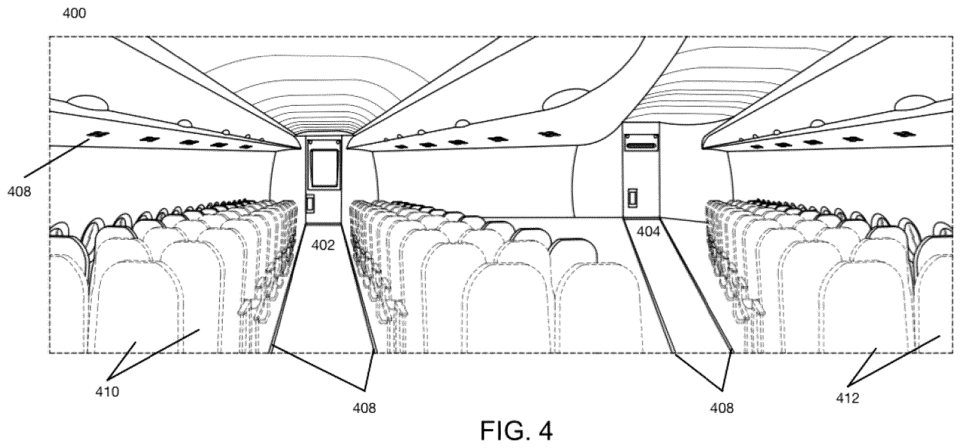

FIG. 4 illustrates an airplane diagram 400 showing the layout of the airplane with aisles illuminated in different colors to guide passengers to their assigned seats. The airplane includes a plurality of aisles 402, 404 that run longitudinally through the fuselage of the aircraft. Each aisle 402, 404 is illuminated by a different color light using a floor lined LED lighting system 408. For example, the left aisle 402 may be illuminated with blue light system, while the right aisle 404 is illuminated with green light system.

The different colored aisles 402, 404 correspond to seat locations within the airplane. Each side of the airplane contains a plurality of seats arranged in rows. The seats are categorized into seat types such as window, middle, and aisle seats. The seats on the left side of the airplane, which are accessed via the blue-illuminated left aisle 402, may be designated as blue seats 410. Similarly, the seats on the right side of the airplane, accessed via the green-illuminated right aisle 404, may be designated as green seats 412.

The airplane diagram 400 is displayed on the boarding pass 300 generated for each passenger by the processor 102. The boarding pass 300 includes an indication 312 of which colored aisle leads to the passenger's assigned seat. For example, if the passenger's assigned seat is on the left side of the airplane, the colored aisle indicator 312 on their boarding pass 300 would specify the blue aisle 402.

Additionally, the boarding pass 300 may include a diagram (not shown) of the airplane seating with a colored pathway from the entrance of the airplane to the passenger's assigned seat. The colored pathway is represented as a dotted line or series of arrows in the color of the appropriate aisle 402 or 404 that leads to the seat. This provides a visual guide for the passenger to follow through the airplane to their seat.

The color-coded aisles 402, 404 and corresponding seat locations may be implemented using multi-color LED light strips embedded into the floor 408, ceiling or sidewalls of the airplane. The LED strips can be individually controlled via the processor 102 and associated control circuitry to illuminate in the designated colors. Alternatively or additionally, the airplane may employ color LCD or OLED displays mounted above the aisles to display the color coding.

The processor 102 accesses the seat assignments and airplane layout information stored in the database 106 to generate the appropriate colored aisle indication and colored pathway diagram for each passenger's boarding pass 300. The boarding pass generation may be implemented using software such as Visual Basic, Java, or C++ to create printable or displayable boarding pass templates that are populated with the customized passenger information and seat mapping data.

The boarding pass 300 may be printed using a high-resolution color printer capable of detailed graphic printing, such as an inkjet or color laser printer. For electronic boarding passes, the data may be formatted into an image file such as PNG or JPEG, or a document format like PDF, for display on a smartphone, tablet or other mobile device screen.

By illuminating each aisle 402, 404 of the airplane with a different color and providing passengers with boarding passes 300 that indicate which colored aisle leads to their assigned seat and includes a colored pathway diagram, the system enables more efficient and orderly boarding of the airplane. Passengers can quickly identify the correct aisle to walk down based on the color coding, reducing confusion and aisle congestion during the boarding process.

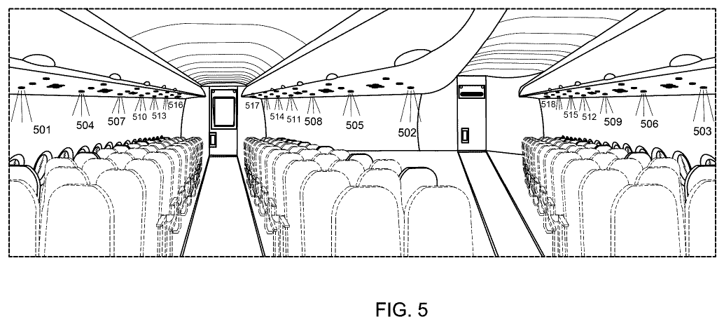

FIG. 5 illustrates an airplane with indicator lights above seats illuminated to guide passengers to their assigned seats.

Lights 501-518 illuminate when passengers ticketed for those seats are assigned to board the airplane. The lights 501-518 can also be illuminated when passengers ticketed for those seats are requested to disembark the aircraft in an orderly fashion.

The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. A computer-implemented system for efficiently boarding passengers onto an airplane, the system comprising:
a database comprising passenger information;
a processor; and
a memory storing instructions that, when executed by the processor, cause the system to perform operations comprising:
assigning, by the processor, boarding numbers to a plurality of passengers; indicator lights above seats on the airplane, wherein the indicator lights are illuminated when passengers ticketed for the seats are boarding the aircraft according to the assigned boarding numbers.

2. A computer-implemented system for efficiently boarding passengers onto an airplane, the system comprising:
a database comprising passenger information including a passenger number, record locator, assigned seat, seat type, priority status, and number of passengers in a party associated with each passenger;
a processor; and
a memory storing instructions that, when executed by the processor, cause the system to perform operations comprising:
assigning, by the processor, an original boarding number to each passenger based on the assigned seat of the passenger, wherein the original boarding numbers are assigned such that passengers with window seats near a rear of the airplane are assigned lower original boarding numbers than passengers with aisle seats near a front of the airplane;
identifying, by the processor, parties of passengers based on identical record locators;
assigning, by the processor, a final boarding number to each passenger in an identified party, wherein the final boarding number for each passenger in the party is a lowest original boarding number assigned to any passenger in the party;
assigning, by the processor, a group number to each passenger based on the final boarding number, wherein passengers with lower final boarding numbers are assigned lower group numbers;
illuminating each aisle of the airplane with a different color;
generating, by the processor, a boarding pass for each passenger including the group number, final boarding number, seat number, seat type, an indication of whether the seat is on a left or right side of the airplane, an indication of which colored aisle leads to the passenger's assigned seat, and a diagram of the airplane seating with a colored pathway from an entrance of the airplane to the passenger's assigned seat; and
controlling, by the processor, a display device to display the boarding number of a next passenger to board the airplane.

3. The system of claim 1, wherein each passenger's boarding pass indicates which colored aisle leads to their assigned seat.

4. The system of claim 1, wherein the diagram of the airplane seating included on the boarding pass shows the colored pathway from the entrance of the airplane to the passenger's assigned seat.

5. The system of claim 1, wherein the display device comprises a plurality of screens positioned at eye level, chest level, waist level, hanging from a ceiling, or on a ground of a boarding area.

6. The system of claim 1, wherein the passenger information further includes a priority category, and wherein the processor is configured to assign the original boarding number to each passenger further based on the priority category of the passenger.

7. The system of claim 1, wherein the processor is configured to assign the final boarding number to each passenger in the identified party by:
determining a lowest original boarding number assigned to any passenger in the party; and
assigning the lowest original boarding number as the final boarding number for each passenger in the party.

8. The system of claim 1, wherein the seat type indicates whether the assigned seat is a window seat, a middle seat, an aisle seat, or a center seat in a row of the airplane having at least four seats.

9. The system of claim 1, wherein the processor is further configured to:
determine a seating configuration of the airplane, the seating configuration including a number of rows, a number of seats per row, and a location of each seat; and
assign the original boarding numbers based on the determined seating configuration.

10. The system of claim 1, wherein the processor is further configured to:
assign passengers with priority status to a priority boarding group that boards before passengers in other boarding groups; and
assign final boarding numbers to passengers within the priority boarding group based on locations of assigned seats, wherein passengers with assigned seats in a rear of the airplane are assigned lower final boarding numbers than passengers with assigned seats in a front of the airplane.

11. The system of claim 1, wherein the passenger information further includes data indicating an amount of carry-on luggage for each passenger, and wherein the processor is further configured to assign the original boarding numbers based on the amount of carry-on luggage for each passenger.

12. The system of claim 1, wherein the processor is further configured to generate visual indicators on each passenger's boarding pass that indicate an amount of carry-on luggage allowed for each passenger based on their assigned seat type.

13. The system of claim 1, wherein the processor is further configured to generate an audio or visual alert when a passenger attempts to board out of order based on the passenger's final boarding number.

14. The system of claim 1, wherein the processor is configured to generate the boarding pass for each passenger to further include a seat map depicting a location of the assigned seat on the airplane.

15. The system of claim 14, wherein the seat map further includes a colored pathway from an entrance of the airplane to the assigned seat.

16. The system of claim 1, wherein the airplane includes a plurality of aisles, and wherein the processor is configured to generate the boarding pass for each passenger to further include an indication of which aisle leads to the assigned seat.

17. The system of claim 1, further comprising:
a second display device,
wherein the processor is further configured to control the second display device to display the boarding number of a second next passenger to board the airplane simultaneously with the next passenger, and
wherein the second next passenger has a final boarding number consecutive with the final boarding number of the next passenger.

18. The system of claim 17, wherein the display device and second display device are positioned to form two boarding lines in a pre-boarding area.

19. A computer-implemented method for efficiently boarding passengers onto an airplane, the method comprising:
storing, by a processor, in a database, passenger information including a passenger number, record locator, assigned seat, seat type, priority status, and number of passengers in a party associated with each passenger;
assigning, by the processor, an original boarding number to each passenger based on the assigned seat of the passenger, wherein the original boarding numbers are assigned such that passengers with window seats near a rear of the airplane are assigned lower original boarding numbers than passengers with aisle seats near a front of the airplane;
identifying, by the processor, parties of passengers based on identical record locators;
assigning, by the processor, a final boarding number to each passenger in an identified party, wherein the final boarding number for each passenger in the party is a lowest original boarding number assigned to any passenger in the party;
assigning, by the processor, a group number to each passenger based on the final boarding number, wherein passengers with lower final boarding numbers are assigned lower group numbers;
generating, by the processor, a boarding pass for each passenger including the group number, final boarding number, seat number, seat type, and an indication of whether the seat is on a left or right side of the airplane; and
displaying, by the processor on a display device, the boarding number of a next passenger to board the airplane.

20. The method of claim 19, wherein the display device is selected from the group consisting of: an electronic screen at eye level, an electronic screen at chest level, an electronic screen at waist level, an electronic screen on a ceiling, an electronic screen hanging from a ceiling, signage on a floor, and signage hanging from a ceiling.
